(19) United States
(12) Patent Application Publication
(10) Pub. No.: US 2012/0276798 A1
(43) Pub. Date: Nov. 1, 2012

(54) LAYERED STRUCTURE OF INFLATABLE PAD

(76) Inventor: SWO-CHUNG CHAI, TAIPEI (TW)

(21) Appl. No.: 13/097,345

(22) Filed: Apr. 29, 2011

(51) Int. Cl. B32B 27/12

(52) U.S. Cl. 442/394

(57) ABSTRACT

A layered structure of inflatable pad includes at least one thermoplastic polyurethane (TPU) film and at least one nonwoven fabric sheet, which are laminated together through application of heat and pressure by a laminating machine. The TPU film is formed by first synthesizing TPU particles with diisocyanate and polyol, heating and melting the particles to a fluid form, and then blow-molding the fluid by a blow-molding machine to form a thin film having a thickness of 0.012-0.2 mm. The layered structure formed by laminating the TPU film and the nonwoven fabric sheet is of a reduced extendibility and increased tensile strength due to the inherent excellent tensile strength of the nonwoven fabric. The layered structure may then be processed by a high-frequency machine or a thermal bonding machine to form various inflatable pads to improve the use comfortableness of the inflatable pads.

### BACKGROUND OF THE INVENTION

1. Field of the Invention

The present invention relates to an improved layered structure of inflatable pad, and in particular to a layered structure that is composed of at least one TPU (Thermoplastic Polyurethane) film and at least one nonwoven fabric sheet, which are laminated to each other by a laminating machine, whereby the mechanical strength of the nonwoven fabric helps realizing low elongation and high tensile strength of the layered structure so as to provide a desired resiliency and use comfortableness to inflatable products made therewith.

2. The Related Arts

An inflatable pad has advantages in respect of light weight, excellent resiliency, easy manufacture, and low cost. Further, according to the desired configuration of a destination inflatable product, an air pad can be made in various forms, such as an air sack, an oxygen bag, an air mattress, an inflatable surface-floating device, an inflatable boat, and an inflatable toy, making it available for extremely wide applications.

However, a conventional inflatable product suffers from certain drawbacks due to the material used to make internal and external layers of an inflatable product being limited to thermoplastic materials. For example, the conventional material used for the layers of an inflatable product suffers from significant extendibility and low tensile strength, making an inflatable product made of such a material over-soft, which in turn leads to excessive deformation when subjected to a minor external force. This is commonly found in for example air mattress and various inflatable surface-floating products. This often causes discomfort to users and makes the operation thereof difficult.

A ready solution for such a problem is to increase the thickness of the layers of an inflatable product. The increased layer thickness can effectively overcome the problems associated with great extendibility and low tensile strength, but at the cost of undesired increase of the total weight of the product and the amount of material consumed. The manufacturing cost is thus raised. The product becomes bulky and heavy, making it difficult for packaging and shipping, and consequently, poor market competition may result.

### SUMMARY OF THE INVENTION

In order to overcome the above discussed problems, the present invention aims to provide an improved layered structure of inflatable pad that reduces extendibility and improves tensile strength.

Thus, a primary objective of the present invention is to provide an improved layered structure of air pad, which comprises at least one TPU (Thermoplastic Polyurethane) film and at least one nonwoven fabric sheet, which are laminated to each other through application of heat and pressure by a laminating machine. The inherent mechanical strength of the nonwoven fabric provides the layered structure with reduced extendibility and increased tensile strength, so as to provide a desired resiliency and use comfortableness to inflatable products made therewith.

To achieve the above objective, the following technical solution is adopted.

In a preferred embodiment according to the present invention, a layered structure is composed of at least one TPU (Thermoplastic Polyurethane) film and at least one nonwoven fabric sheet that are lamented to each other through applications of heat and pressure by a laminating machine.

The TPU film used in the layered structure is made by first synthesizing TPU particles with diisocyanate and polyol, heating and melting the particles to a fluid form, and blow-molding the fluid with a blow-molding machine to form a TPU film having a thickness of 0.012-0.2 mm.

The TPU film so made and a nonwoven fabric are laminated together through applications of heat and pressure to form a thin sheet like layered material. In this process of applying heat and pressure, no glue or adhesive is used.

The layered structure formed by laminating the TPU film and the nonwoven fabric sheet uses the inherent property of excellent tensile strength of the nonwoven fabric to reduce the extendibility of the layered structure and improve the tensile strength thereof.

The TPU film so made can be formed with various thicknesses so that the layered structure formed of the lamination of the TPU film and the nonwoven fabric through applications of heat and pressure can be of different overall thicknesses.

The layered structure can be selected with different thickness according to the type and configuration of an intended air or inflatable product. A high-frequency machine or a thermal bonding machine may be used to process the layered structure to form various inflatable pad for manufacturing various forms of inflatable/air products, including an air sack, an oxygen bag, an air mattress, an inflatable surface-floating device, an inflatable boat, and an inflatable toy.

Since the layered structure of inflatable pad according to the present invention has the properties of low extendibility and high tensile strength, when it is used to make an inflatable/air product, such as an air mattress or various inflatable surface-floating devices, it significantly improves the use comfortableness and operation easiness of the air pad and overcomes the drawbacks of conventional inflatable products of the same kind.

### BRIEF DESCRIPTION OF THE DRAWINGS

The present invention will be apparent to those skilled in the art by reading the following description of preferred embodiments thereof, with reference to the attached drawings, wherein:

FIG. 1 is a perspective view showing an inflatable pad manufactured with a layered structure according to the present invention;

FIG. 2 is a cross-sectional view of a portion of the air pad of FIG. 1;

FIG. 3 is a cross-sectional view showing a layered structure according to a first embodiment of the present invention;

FIG. 4 is a cross-sectional view showing a layered structure according to a second embodiment of the present invention; and

FIG. 5 is a cross-sectional view showing a layered structure according to a third embodiment of the present invention.

### DETAILED DESCRIPTION OF THE PREFERRED EMBODIMENTS

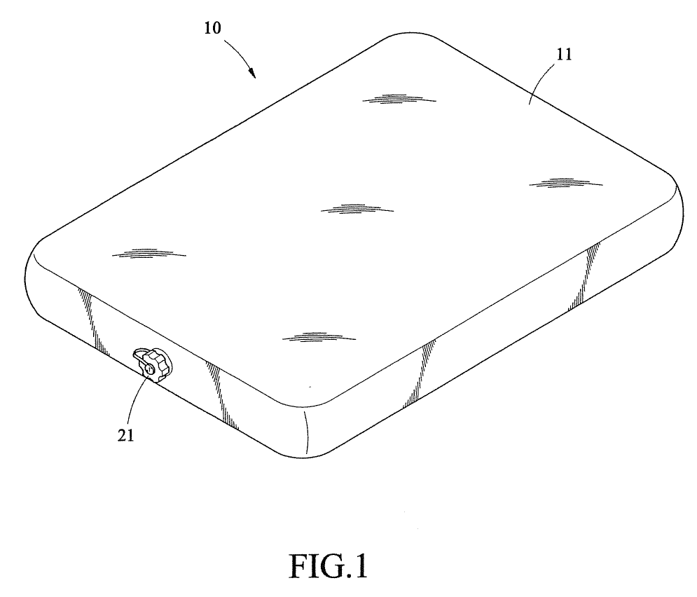

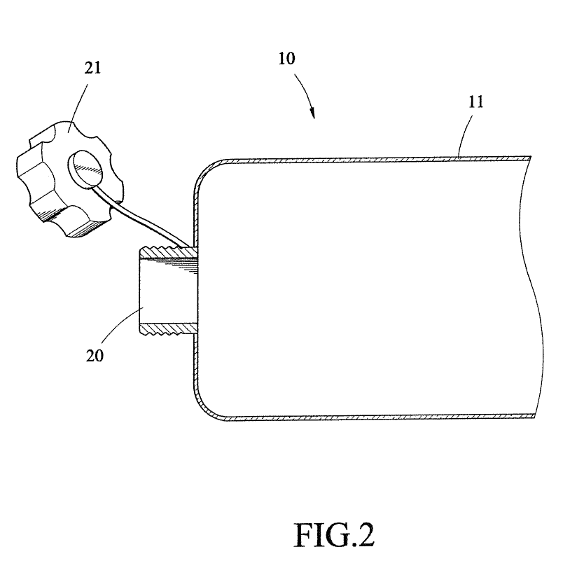

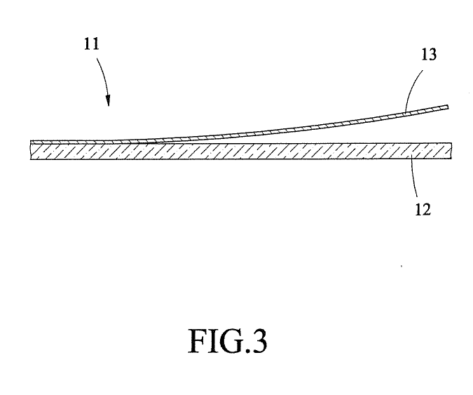

With reference to the drawings and in particular to FIGS. 1-3, FIG. 1 shows an inflatable pad, generally designated at 10, manufactured with a layered structure 11 according to the present invention; FIG. 2 is a cross-sectional view of a portion of the air pad 10 of FIG. 1; and FIG. 3 is a cross-sectional view showing the layered structure 11 according to the present invention.

As shown in FIG. 3, in a preferred embodiment according to the present invention, the layered structure 11 is composed of at least one TPU (Thermoplastic Polyurethane) film 12 and at least one nonwoven fabric sheet 13 that are lamented to each other through applications of heat and pressure by a laminating machine.

The TPU film 12 used in the layered structure 11 is made by first synthesizing TPU particles with diisocyanate and polyol, heating and melting the particles to a fluid form, and blow-molding the fluid with a blow-molding machine to form a TPU film having a thickness of 0.012-0.2 mm.

The TPU film 12 and the nonwoven fabric sheet 13 are laminated together through applications of heat and pressure to form a thin sheet like layered structure 11. In this process of applying heat and pressure, no glue or adhesive is used.

The nonwoven fabric 13 is not limited to any specific specification and can be any nonwoven fabric that is readily available in the market. The nonwoven fabric 13 can be any nonwoven fabric that can be laminated to the TPU film 12 through applications of heat and pressure by the laminating machine to improve the tensile strength of the layered structure 11.

The TPU film 12 so made can be formed with various thicknesses so that the layered structure 11 formed of the lamination of the TPU film 12 and the nonwoven fabric 13 through applications of heat and pressure can be of different overall thicknesses.

The layered structure 11 can be selected with different thickness according to the type and configuration of an intended inflatable product 11 to be manufactured. A high-frequency machine or a thermal bonding machine may be used to process the layered structure 11 to form inflatable pads of various forms, such as the inflatable pad 10 shown in FIGS. 1 and 2.

In the embodiment shown in FIGS. 1 and 2, the inflatable pad 10 is made in the form of an air mattress to thereby serve as an air mattress. The air pad 10 may include a valve 20 with a sealing cap 21 arranged at one side of the air pad for charging air into the air pad 10 to inflate the air pad 10 into a usable condition, or to release air from the air pad by opening the valve 20 so that the deflated air pad 10 can be rolled up for storage.

The air pad 10 is manufactured with the layered structure 11 according to the present invention, so that the pad itself shows reduced extendibility and increased tensile strength, and thus overcomes the drawbacks of the conventional products of the same kind that is over-soft and suffers from excessive deformation due to minor external force applied thereto and greatly improves use comfortableness and operation easiness of the product.

The air pad 10 shown in FIGS. 1 and 2 is only an illustrative example of the application of the layered structure 11 according to the present invention. The layered structure 11 can be selected with different thickness to make various inflatable/air products for different purposes according to the type of an intended inflatable/air product, such as an air sack, an oxygen bag, an air mattress, an inflatable surface-floating device, an inflatable boat, and an inflatable toy.

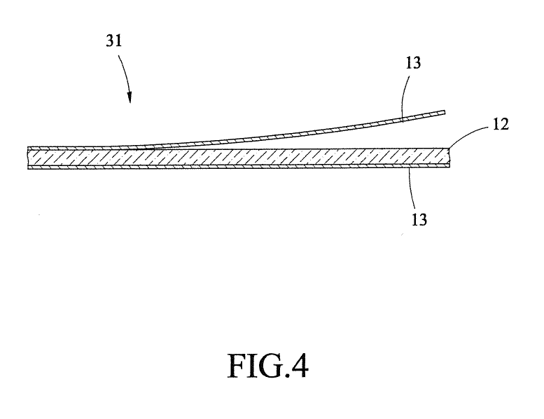

FIG. 4 shows a layered structure according to a second embodiment of the present invention, generally designated at 31.

The layered structure 31 according to the second embodiment of the present invention is composed of a TPU film 12 and two nonwoven fabric sheets 13, which are laminated to each other through applications of heat and pressure by a laminating machine. The structural feature is that one of the nonwoven fabric sheets 13 is laminated to a top surface of the TPU film 12, while another nonwoven fabric sheet 13 is laminated to a bottom surface of the TPU film 12.

In this embodiment, the layered structure 31 comprises two layers of nonwoven fabric 13, so that the layered structure 31 is of better tensile strength as compared to the layered structure 11 that is composed of a single layer of TPU film 12 and a single layer of nonwoven fabric 13, making it better suitable for making inflatable/air products that require high tensile strength.

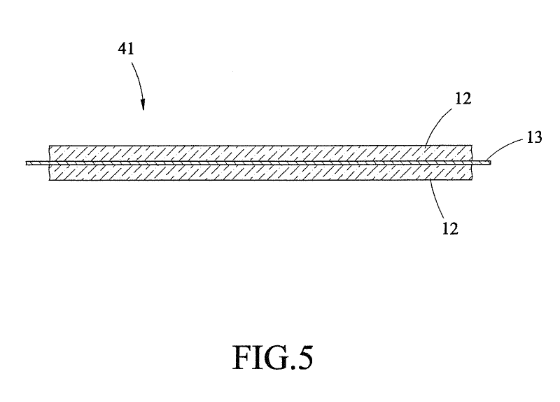

FIG. 5 shows a layered structure according to a third embodiment of the present invention, generally designated at 41.

The layered structure 41 according to the third embodiment of the present invention is composed of two TPU films 12 and a nonwoven fabric sheet 13, which are laminated to each other through applications of heat and pressure by a laminating machine. The structural feature is that the nonwoven fabric sheet 13 is interposed between the two TPU films 12.

In this embodiment, the layered structure 41 comprises two layers of TPU films 12, so that the layered structure 41 is of better resiliency and better tensile strength as compared to the layered structure 11 that is composed of a single layer of TPU film 12 and a single layer of nonwoven fabric 13, making it better suitable for making inflatable/air products that require high resiliency.

In practical applications, the layered structure of inflatable pad according to the present invention can be alternatively composed of multiple TPU films 12 and multiple nonwoven fabric sheets 13, which are laminated together through applications of heat and pressure by a laminating machine in order to manufacture layered structures of various resiliencies and tensile strengths to thereby expand the applications of the layered structure according to the present invention.

Although the present invention has been described with reference to the preferred embodiments thereof, it is apparent to those skilled in the art that a variety of modifications and changes may be made without departing from the scope of the present invention which is intended to be defined by the appended claims.

What is claimed is:

1. A layered structure, comprising:
at least one thermoplastic polyurethane (TPU) film, which is formed by synthesizing particles with diisocyanate and polyol, heating and melting the particles to a fluid form, and then blow-molding the fluid by a blow-molding machine; and
at least one nonwoven fabric sheet, which is laminated to the TPU film through application of heat and pressure by a laminating machine to form the layered structure.

2. The layered structure as claimed in claim 1, wherein the TPU film has a thickness of 0.012-0.2 mm.

3. The layered structure as claimed in claim 1, wherein the nonwoven fabric sheet is made of market available nonwoven fabric.

4. The layered structure as claimed in claim 1, wherein the layered structure comprises a TPU film and two nonwoven fabric sheets, which are laminated together through application of heat and pressure by a laminating machine to have one of the nonwoven fabric sheets attached to a top surface of the TPU film and the other one of the nonwoven fabric sheets attached to a bottom surface of the TPU film.

5. The layered structure as claimed in claim 1, wherein the layered structure comprises two TPU films and a nonwoven fabric sheet, which are laminated together through application of heat and pressure to have the nonwoven fabric sheet interposed between the two TPU films.
